(19) United States
(12) Patent Application Publication
(10) Pub. No.: US 2022/0298971 A1
(43) Pub. Date: Sep. 22, 2022

(54) METHOD FOR PROTECTING AN AIRCRAFT ENGINE ON SPIN-UP

(71) Applicant: Airbus Operation (S.A.S), Toulouse (FR)

(72) Inventors: Gilian Antonio, Toulouse (FR); David Boyer, Toulouse (FR)

(21) Appl. No.: 17/696,392

(22) Filed: Mar. 16, 2022

(30) Foreign Application Priority Data
Mar. 17, 2021 (FR) 2102680

(51) Int. Cl. F02C 7/26; F02C 9/00

(52) U.S. Cl. CPC F02C 7/26; F02C 9/00

(57) ABSTRACT

A method for protecting, on spin-up, an aircraft engine including a power supply source, an engine with a rotor and associated with a starter system to, when supplied with power, produce a mechanical force to spin the rotor. The method includes an acquisition step performed continuously, wherein the engine control avionics acquire rotational speed of the rotor, a comparison step wherein the engine control avionics continuously compare acquired rotational speed against a predetermined rotational speed, and a checking step wherein the engine control avionics check that rotation of the rotor corresponds to deliberate pilot action, and if so, the engine control avionics authorize supply of power to the starter system, and, if not, in a deactivation step, the engine control avionics disconnect the engine starter system from its power supply source in order to stop the rotation of the rotor.

### CROSS-REFERENCE TO RELATED APPLICATION

This application claims priority to French patent application number 2102680 filed on Mar. 17, 2021, the entire disclosure of which is incorporated by reference herein.

### TECHNICAL FIELD

The disclosure herein relates to a method for protecting an aircraft engine on spin-up during phases on the ground, and to an aircraft equipped with engine control avionics for implementing such a method.

### BACKGROUND

It is known that, after an aircraft has spent time on the ground following a flight, a thermal gradient in the rotor of each engine, which is still hot, causes certain blades and/or the rotor to expand, leading them to deform and thereby bringing about a reduction in the axial or diametral clearance with respect to the normal axis of rotation of the blading, expansion of the blades, etc.

From a practical standpoint, it is not advisable for an engine to be restarted after a short waiting time (of less than one hour and thirty minutes), because if the engine has not had time to cool sufficiently, it is possible that, on restarting, the tips of some of the rotor blades will rub against the casing and/or that a blade set will deviate from its axis of rotation. This phenomenon, known as “bowed rotor”, is at risk of occurring until such point as the temperature between the blade sets becomes uniform as a result of the engine turning.

In a known way, an electric or pneumatic starter system is used to start an engine. The starter system, when activated is supplied with power, provides a mechanical source for spinning a rotor of the compressor stage, referred to as the rotor N2, of the engine. The rotor N2 can be spun at a low speed to provide ventilation for the engine in order to dissipate thermal gradient and therefore even out the temperature between the blade sets, or at a higher speed in order to ventilate the engine or even to allow the engine to be ignited after fuel has been injected into the appropriate parts of the engine, which have been spun up by the rotor N2.

According to the logic that predominates in aeronautical engineering for increasing the safety mechanisms, there is a need to confirm that the spinning-up of the rotor N2 into an engine does actually correspond to the intentions of the pilot so as to avoid any damage to the engine if it has not had time to cool down.

### SUMMARY

There is therefore a need to prevent any uncontrolled spin-up of an engine. To this end, the disclosure herein relates to a method for protecting, on spin-up, an engine of an aircraft comprising command controls that can be actuated by a pilot, an engine equipped with a rotor and associated with a starter system, a power supply circuit with a power supply source and a control system that can be operated via the command controls to connect/disconnect the starter system and the power supply source, engine control avionics connected to the command controls and configured to provide control of the engine according to the actions on the command controls, the avionics comprising rotation sensors arranged on the engine to measure the rotational speed of the rotor, the starter system comprising an actuator connected to the power supply circuit through a regulating device operated by the engine control avionics to regulate the supply of power to the actuator, the actuator being mechanically connected to the rotor and configured to spin the rotor when supplied with power, the engine control avionics also being connected to the control system, the method being characterized in that it comprises the following steps:
an acquisition step performed continuously and in which the engine control avionics acquire the rotational speed of the rotor as measured by the sensors;
a comparison step, in which the engine control avionics compare, continuously, the acquired rotational speed against a predetermined rotational speed;
a checking step in which the engine control avionics check that the rotation of the rotor is consequent on pilot interaction with the command controls; and
   if the rotation of the rotor is consequent on pilot interaction with the command controls, the engine control avionics authorize the supply of power to the starter system and, if not, in a deactivation step, the engine control avionics generate a control signal to the control system to disconnect the engine starter system from the power supply source in order to stop the rotation of the rotor.

The disclosure herein makes it possible to prevent unintentional activation of the starter system which could, for example, be caused by a short circuit (in the case of an electrical starter system) or poor management of the pneumatic circuit of the aircraft (in the case of a pneumatic starter system).

The disclosure herein also relates to an aircraft comprising command controls that can be actuated by a pilot, an engine equipped with a rotor and associated with a starter system, a power supply circuit with a power supply source and a control system that can be operated via the command controls to connect/disconnect the starter system and the power supply source, engine control avionics connected to the command controls and configured to provide control of the engine according to the actions on the command controls, the avionics comprising rotation sensors arranged on the engine to measure the rotational speed of the rotor, the starter system comprising an actuator connected to the power supply circuit through a regulating device operated by the engine control avionics to regulate the supply of power to the actuator, the actuator being mechanically connected to the rotor and configured to spin the rotor when supplied with power, characterized in that the engine control avionics is also connected to the control system and is configured to operate the system to disconnect the engine starter system and the power supply source according to the speed value measured by the sensors and according to absence of action on the command controls intended to spin the rotor.

### BRIEF DESCRIPTION OF THE DRAWINGS

The abovementioned features of the disclosure herein, together with others, will become more clearly apparent on reading the following description of one exemplary embodiment, the description being given in connection with the attached drawings, of which:

FIG. 1 is a schematic view from above of an aircraft equipped with two turbomachines of which the engines are controlled by engine control avionics and which is equipped with a pneumatic power supply circuit according to one embodiment of the disclosure herein;

FIG. 2 is a detailed schematic view of the connection between the engine control avionics, the pneumatic power supply circuit and a turbomachine of the aircraft depicted in FIG. 1;

FIG. 3 is a schematic view of the steps of a method for protecting each engine on spin-up, which method is implemented by the engine control avionics of the aircraft depicted in FIG. 1;

FIG. 4 is a schematic view from above of an aircraft equipped with two turbomachines of which the engines are controlled by an engine control avionics and which is equipped with an electrical power supply circuit according to another embodiment of the disclosure herein;

FIG. 5 is a detailed schematic view of the connection between the engine control avionics, the electrical power supply circuit and a turbomachine of the aircraft depicted in FIG. 4;

FIG. 6 is a schematic view of the steps of a method for protecting each engine on spin-up, which method is implemented by the engine control avionics of the aircraft depicted in FIG. 4.

### DETAILED DESCRIPTION

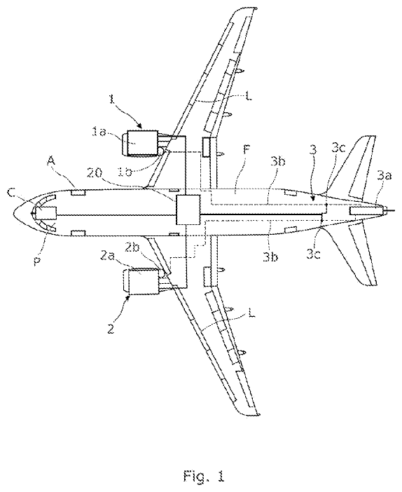

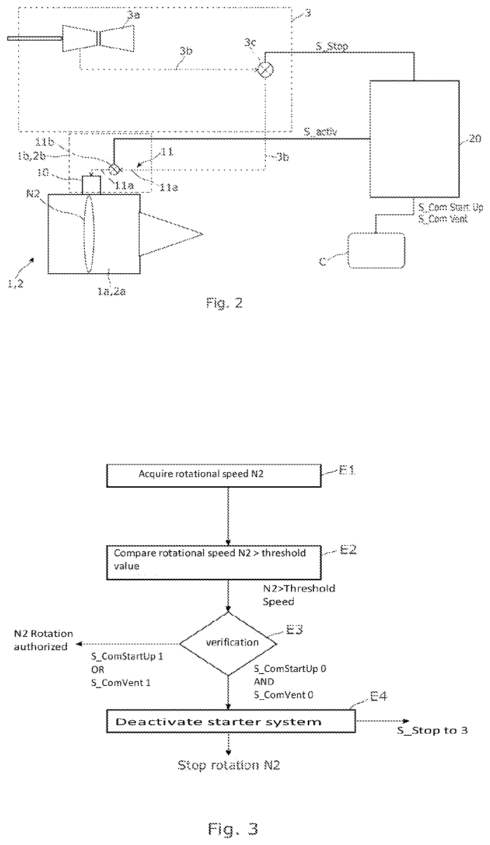

With reference to FIGS. 1 and 2, an aircraft A comprises a turbomachine 1, 2 mounted each wing L of the aircraft and a pneumatic power supply circuit 3 able to supply air to various aircraft systems, notably cabin systems (not depicted) or the turbomachines 1, 2. The pneumatic power supply circuit 3 comprises a pneumatic power source 3a to produce a flow of air when activated, various airlines 3b to convey the air from the pneumatic power source to the systems, and a control system 3c that can be operated to pneumatically connect, or on the other hand disconnect, the pneumatic power source 3a and each of the various systems in order to control the distribution to the systems of the air flow produced. The pneumatic power source 3a is, for example, an auxiliary power unit (APU) housed in the fuselage F of the aircraft.

The control system 3c comprises at least one actuator (not depicted), for example of the shutoff valve type.

Each turbomachine 1, 2 comprises an engine 1a, 2a and, associated with each engine, an engine starter system 1b, 2b.

The engine starter system 1b, 2b comprises an actuator 10 of the starter turbine type, mechanically connected to the rotor and pneumatically connected to the pneumatic power supply circuit 3 through a regulating device 11b such as a starter air valve (SAV) 11b arranged upstream of the starter turbine 10 when considering the direction of flow of the air leaving the pneumatic power source 3a (and indicated by arrows in FIG. 2). More specifically, the starter air valve 11b is pneumatically connected, on the one hand, to the starter turbine 10 by a first air duct 11a and, on the other hand, to an airline 3b of the pneumatic power supply circuit 3 by a second air duct 11a.

The starter air valve 11b is configured to regulate the flow rate of air entering the starter turbine 10 and to this end can be commanded electronically between an open position in which it allows air in the first air duct 11a to enter the starter turbine, and a closed position in which it blocks the passage of air. The starter air valve 11b may also, in the event of a failure of its electronics, be forced manually into an open position by a ground operator so that the engine 1a, 2a can be started despite this failure and without awaiting a repair which would involve grounding the aircraft A for a lengthy period.

The starter turbine 10 is able, when subjected to a flow of air from the pneumatic supply source 3a, to produce a mechanical force able to spin up the rotor N2 of the engine 1a, 2a. The air flow supplied by the pneumatic supply source 3a is thus used to start/ventilate each engine 1a, 2a before take off. The starter air valve 11b is able to regulate the mechanical force produced by the starter turbine 10 between zero force (when the starter air valve is in the closed position) and maximum force (when the starter air valve is in the open position).

The aircraft A also comprises engine control avionics 20 which monitor and control the engines 1a, 2a and which also comprise command controls C located on the flight deck P, and on which the pilot can act in order to fly the aircraft. The command controls C are electrically connected to the controllable control system 3c of the pneumatic supply circuit 3 and to the engine control avionics 20. The command controls C comprise, for example, interfaces of the switch, lever or button type which in particular allow the control system 3c of the pneumatic supply circuit 3 to be operated and allow the engine control avionics 20 to be given instructions for controlling/operating the engines 1a, 2a. In particular, the pilots use the command controls C to instruct the engine control avionics 20 to initiate a procedure for starting or a procedure for ventilating the engine.

The engine control avionics 20 comprise, for each engine 1a, 2a:
a plurality of sensors (not depicted) arranged on the engine 1a, 2a in order to monitor the operation of the engine and, in particular, to measure the rotational speed of the rotor N2 of the engine 1a, 2a;
computers (not depicted) of the central processor type, to each operate the engine 1a, 2a, the engine components (pumps, valves such as fuel valves—not depicted) and the starter system 1b, 2b (notably the position of the engine starter air valve 11b) according to information from the sensors and actions of the pilot on the command controls C.

In Boolean logic, when a pilot interacts with the command controls C to start an engine 1a, 2a, the bit of a signal S_ComStartUp, in the engine control avionics 20, changes state. For example, the bit of the signal S_ComStartUp changes from 0 to 1. Likewise, when a pilot interacts with the engine control member to ventilate an engine, the bit of a signal S_ComVent in the engine control avionics 20 changes state. For example, the bit of the signal S_ComVent changes from 0 to 1.

Upon the change in state of the signal S_ComStartUp, changing to 1 in the above example, the engine control avionics 20 send a control signal S_active to the starter air valve 11b to cause the latter to move from its closed position to its open position so as, if the pneumatic supply source 3a is activated, to initiate the spinning of the rotor N2 up to a starting speed.

Upon the change in state of the signal S_ComVent, changing to 1 in the above example, the engine control avionics 20 send a control signal S_active to the starter air valve 11b to make it move from its closed position to its open position so as, if the pneumatic supply source is activated, to initiate the spinning of the rotor N2 up to a ventilation speed (ventilation speed less than starting speed).

The difference in rotational speed between the ventilation speed and the starting speed is obtained in the known way through implementation of various known systems.

According to the disclosure herein, the engine control avionics 20 are, for each turbomachine 1, 2, connected to the pneumatic power supply circuit control system 3c which connects/disconnects the engine starter system 1b, 2b and the pneumatic power supply source 3a. Furthermore, the engine control avionics implement a method for protecting the engine 1a, 2a on spin-up, allowing the engine 1a, 2a to be kept safe through operation of the control system 3c in order to cause the mechanical force that allows the rotor N2 to be spun to cease if rotation of the rotor N2 beyond a certain threshold speed is detected and if this rotation does not correspond to pilot intent.

The method implemented for an engine 1a, 2a and detailed in connection with FIG. 3 comprises the following successive steps:

In an acquisition step E1 performed continuously, the engine control avionics 20 acquire the rotational speed of the rotor N2 as measured by the sensors.

In a comparison step E2, the engine control avionics 20 continuously compare the acquired rotational speed of the rotor N2 against a predetermined rotational speed, known as threshold speed, which corresponds to the minimum rotational speed past which the sensors are configured to supply rotational speed data (technical characteristics of the sensor). This speed is below the rotational speed of the ventilation regime. As an idea of orders of magnitude, for a rotational speed of the rotor N2 at 100% when the rotor N2 is rotating at its maximum rotational speed, the rotational speed for the ventilation regime is the order of 25% and the threshold speed is of the order of 1 to 3%.

In a checking step E3 which is performed if the acquired rotational speed of the rotor N2 is greater than or equal to the threshold rotational speed for a predetermined length of time (for example from 1 to 5 seconds), the engine control avionics 20 check that the rotation of the rotor N2 does correspond to pilot intent. To do that, the engine control avionics 20 check that the pilot has previously interacted with the command controls C to select the procedure for starting or the procedure for ventilating the engine 1a, 2a. In concrete terms, the engine control avionics 20 check that the signal S_ComStartUp or the signal S_ComVent has adopted a state (in this example switched from 0 to 1) indicative of the selection of a starting or ventilation sequence respectively. If it has, the rotation of the rotor N2 is deliberate and no action to stop the rotation is undertaken by the engine control avionics 20.

If not, if neither the signal S_ComStartUp nor the signal S_ComVent has adopted a state indicative of the selection of a starting or ventilation sequence respectively, and in a deactivation step E4, the engine control avionics 20 generate and issue to the control system 3c a control signal S_Stop to disconnect the engine starter system 1b, 2b and the power source 3a in order to stop the mechanical force supplied by the actuator 10 and that is causing the rotor N2 to spin.

The disclosure herein protects the engines against unintentional spin-up of its rotating parts. The disclosure herein notably finds an application in instances in which the starter air valve 11b may have been placed manually in the open position and in which the pneumatic ventilation source 3a, which may have been switched on with the intention of supplying air to systems situated in the aircraft cabin prior to take off, is also, as a result of poor management of the pneumatic power supply circuit 3 on the part of the ground crews, supplying air to the engine starter system 1b, 2b.

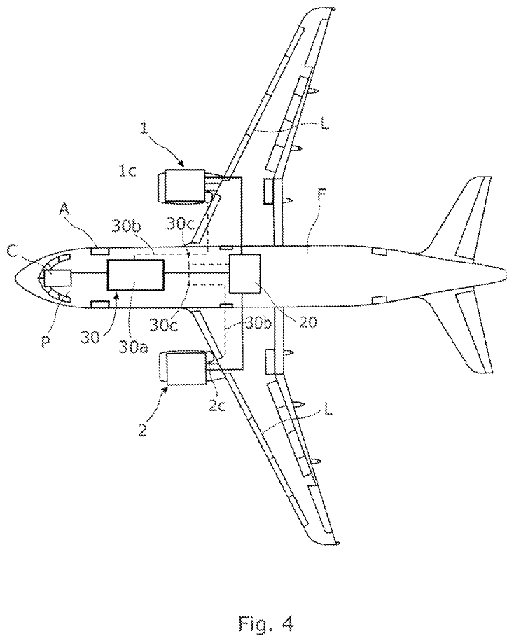

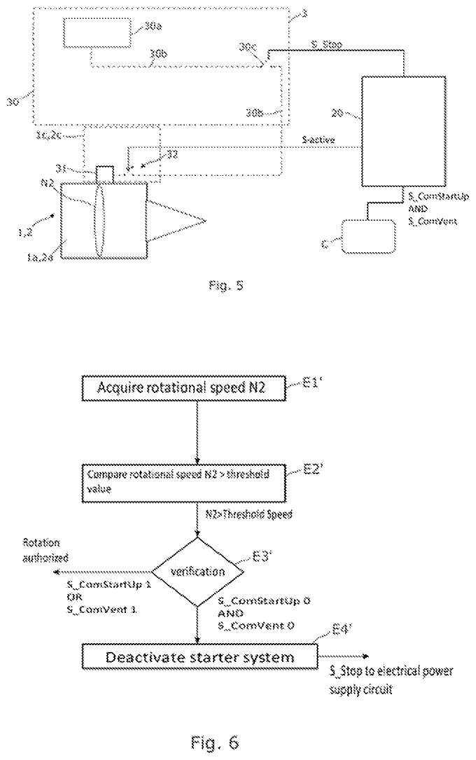

The disclosure herein has been described for the case where the engine starter system 1b, 2b is a pneumatic system. In connection with FIGS. 4 and 5, the disclosure herein also finds applications to an electrical engine starter system 1c, 2c. In the known way, an aircraft A comprises an electrical power supply circuit 30 which comprises an electrical power supply source 30a of the battery or electric generator type to supply electrical power to the aircraft systems (notably the engine control avionics, the command controls, etc.), various wires 30b connecting the systems of the aircraft A including the engine starter systems 1b, 2b to the electrical power supply source 30a, and a control system 30c, which elements can be operated via the command controls C. The control system 30c comprises at least one element of the relay/circuit breaker type for connecting or disconnecting the electrical power supply source 30a and each of the various systems in order to control the distribution of electrical current to the systems. In normal operation, the electric starter systems 1c, 2c for each engine is connected to the electrical power supply source 30a.

It will be noted that the electrical power supply circuit has not been depicted in FIG. 1 in order not to overload FIG. 1, even though this circuit is present in all aircraft.

The electric starter system 1c, 2c for an engine comprises an actuator 31 of the electric motor type mechanically connected to the rotor N2 and electrically connected to the electrical power supply circuit 30 through a regulating device 32 placed in series between a cable 30b of the electric power supply circuit 30 and the electric motor 31.

The regulating device 32, of the rheostat/potentiometer type, can be instructed by the engine control avionics 20 to modify the strength of the current received by the electric motor 31 between a maximum current strength supplied by the electric power supply source and zero current.

The electric motor 31 is able, when supplied with electrical power from the electric power supply source 30a, to produce a mechanical force allowing the rotor N2 of the engine to be spun up. The rheostat/potentiometer is able to regulate the mechanical force produced by the electric motor 31 between zero force (no current) and maximum force (maximum current strength).

Returning to the previous example but applying it this time to the case of electrical engine starter systems 1c, 2c, upon the changing state of the signal S_ComStartUp to a state indicative of the selection of a starting or ventilating sequence respectively, the engine control avionics 20 send a control signal S_active to the regulating device 32 in order to power the electric motor 31 so as to initiate the spinning-up of the rotor N2 up to a starting speed.

Upon the change in state of the signal S_ComVent to a state indicative of the selection of a starting or ventilation sequence respectively, the engine control avionics 20 send a control signal S_active to the regulating device 32 to power the electric power 31 in order to initiate the spinning-up of the rotor N2 to a ventilation speed.

In this disclosure herein embodiment specific to an engine starter system comprising an electric starter motor 1c, 2c, and in connection with FIGS. 4 and 5, the engine control avionics 20 are, for each turbomachine 1, 2, connected to the control system 30c that controls the electrical power supply circuit 30 for connecting/disconnecting the engine starter system 1c, 2c and the electrical power supply source 30a. Furthermore, the engine control avionics 20 perform a method of protecting the engine 1a, 2a on spin-up, allowing the engine 1a, 2a to be made safe by operating the control system 30c to cause the mechanical force that is allowing the rotor N2 to be spun to be made to cease if a rotation of the rotor N2 beyond a certain threshold is detected and if this rotation does not correspond to pilot intent.

With reference to FIG. 6, in this embodiment with an electric starter system 1c, 2c, the method implemented by the engine control avionics 20 comprises the same steps of acquisition E1′, comparison E2′ and checking E3′ as those described above. The deactivation step E4′ is, however, different in that the control signal S_stop is issued this time to the control system 30c that allows the connecting/disconnecting of the engine starter system 1b, 2b and the electrical power supply source 30a. On receipt of the control signal S_stop, the control system 30c disconnects the engine starter system 1b, 2b from the electrical power supply source 30a in order to stop the mechanical force supplied by the engine starter system 1b, 2b and that is causing the rotor N2 to spin.

This embodiment notably finds applications in instances in which the motor of the electrical starter system 1c, 2c has brought about unintentional and uncontrolled spinning-up of the rotor N2 as a result of an electrical failure (a fault in the instruction for example) affecting the regulating device 32a.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for protecting, on spin-up, an engine of an aircraft comprising command controls that can be actuated by a pilot, an engine equipped with a rotor and associated with a starter system, a power supply circuit with a power supply source and a control system that can be operated via the command controls to connect/disconnect the starter system and the power supply source, engine control avionics connected to the command controls and configured to provide control of the engine according to actions on the command controls, the avionics comprising rotation sensors on the engine to measure a rotational speed of the rotor, the starter system comprising an actuator connected to the power supply circuit through a regulating device operated by the engine control avionics to regulate supply of power to the actuator, the actuator being mechanically connected to the rotor and configured to spin the rotor when supplied with power, the engine control avionics also being connected to the control system, the method comprising:
an acquisition step performed continuously and in which the engine control avionics acquire the rotational speed of the rotor as measured by the sensors;
a comparison step, in which the engine control avionics compare, continuously, the acquired rotational speed against a predetermined rotational speed;
a checking step in which the engine control avionics check that the rotation of the rotor is consequent on pilot interaction with the command controls; and
if the rotation of the rotor is consequent on pilot interaction with the command controls, the engine control avionics authorize the supply of power to the starter system and, if not, in a deactivation step, the engine control avionics generate a control signal to the control system to disconnect the engine starter system from the power supply source to stop the rotation of the rotor.

2. An aircraft comprising command controls that can be actuated by a pilot, an engine equipped with a rotor and associated with a starter system, a power supply circuit with a power supply source and a control system that can be operated via the command controls to connect/disconnect the starter system and the power supply source, engine control avionics connected to the command controls and configured to provide control of the engine according to actions on the command controls, the avionics comprising rotation sensors on the engine to measure a rotational speed of the rotor, the starter system comprising an actuator connected to the power supply circuit through a regulating device operated by the engine control avionics to regulate supply of power to the actuator, the actuator being mechanically connected to the rotor and configured to spin the rotor when supplied with power, wherein the engine control avionics are also connected to the control system and are configured to operate the system to disconnect the engine starter system and the power supply source according to a speed value measured by the sensors and according to absence of action on the command controls intended to spin the rotor.
